(19) United States
(12) Patent Application Publication
(10) Pub. No.: US 2013/0080539 A1
(43) Pub. Date: Mar. 28, 2013

(54) SYSTEMS AND METHODS FOR PERFORMING QUICK LINK COMMUNICATIONS

(71) Applicants: Cheng-Shiun Jan, Taoyuan County (TW); Chun-Hsiang Huang, Taoyuan County (TW); Ching-Liang Chiang, Taoyuan County (TW); Wei-Chung Yang, Taoyuan County (TW)

(72) Inventors: Cheng-Shiun Jan, Taoyuan County (TW); Chun-Hsiang Huang, Taoyuan County (TW); Ching-Liang Chiang, Taoyuan County (TW); Wei-Chung Yang, Taoyuan County (TW)

(73) Assignee: HTC CORPORATION, Taoyuan City (TW)

(21) Appl. No.: 13/239,809

(22) Filed: Sep. 22, 2011

(51) Int. Cl. G06F 15/16

(52) U.S. Cl. 709/206; 709/227

(57) ABSTRACT

Various systems and methods for performing quick link communications are described. One embodiment is a method for initiating communications on a communications device. The method comprises retrieving, by the communications device, communication information from a display terminal, the communication information being derived by the display terminal. The method further comprises displaying, by the communications device, at least one quick link according to the communication information. Based on a user input relating to the at least one quick link, a communications session is initiated by the communications device.

### TECHNICAL FIELD

The present disclosure generally relates to systems and methods for performing quick link communications.

### BACKGROUND

With the rapid development in communications technology, mobile devices have become an integral part of many people's lives given the portability, the convenient access to the Internet, and the growing number of applications available on mobile devices. Today, individuals can perform a wide range of functions such as e-mail communications, web surfing, electronic commerce, etc. via mobile devices.

It is common for such information as telephone numbers, Uniform Resource Locators (URLs), e-mail addresses, and other forms of communication information to be conveyed to viewers via television programs, advertisements, etc. For example, home shopping channels are a popular means for viewers to purchase items in the comfort of their own home. However, to take advantage of an advertised promotion, a viewer needs to somehow retain the information by, for example, writing down the information down (e.g., a phone number, URL, etc.) and then performing the additional step of manually placing a phone call or typing in an URL to navigate to the designated website to conduct the transaction. Thus, even with the convenience of mobile devices, one will appreciate that this can be tedious and inefficient, particularly if the information is conveyed for only a brief period of time. Thus, various perceived shortcomings exist with existing mechanisms for conveying such information to viewers.

### SUMMARY

Briefly described, one embodiment, among others, is a method for initiating communications on a communications device. The method comprises retrieving, by the communications device, communication information from the display terminal, the communication information being derived by a display terminal. The method further comprises displaying, by the communications device, at least one quick link according to the communication information. Based on a user input relating to the at least one quick link, a communications session is initiated by the communications device.

Another embodiment is a system that comprises a communications device, the communications device comprising a receiver configured to establish a connection with a display terminal and retrieve communication information from the display terminal, the communication information being derived by the display terminal from media content associated with the communication information. The communications device further comprises interface logic for providing a user interface comprising at least one quick link for initiating communications according to the communication information and communications logic configured to initiate communications based on at least one selection by a user of the at least one quick link.

Another embodiment is a non-transitory computer-readable medium embodying a program executable in a computing device. The program comprises code for retrieving communication information from a display terminal, code for displaying at least one quick link for initiating communications according to the communication information using the device, and code for initiating communications based on input from a user responsive to the at least one quick link being displayed.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts a top-level diagram of networked environment in which a communications device and a display terminal operate in accordance with the quick link techniques described.

FIG. 2 is an example user interface on the communications device in which communication information is shown.

FIG. 3 illustrates an embodiment of the communications device in FIG. 2.

FIG. 4 is a flowchart in accordance with one embodiment for providing quick links.

FIG. 5 is a flowchart in accordance with another embodiment for providing quick links.

FIGS. 6A-B show various embodiments of the display terminal of FIG. 1 for implementing the quick link technique described.

FIG. 7 is a flowchart in accordance with another embodiment for providing quick links, whereby processing of media content is performed locally at the communications device.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

As advertisements are being shown on a display, it is common for such communication information as telephone numbers, Uniform Resource Locators (URLs), e-mail addresses and other forms of communication information to be conveyed to viewers. To take advantage of an advertised promotion, a viewer needs to somehow retain the information by, for example, writing down the information down (e.g., a phone number, URL, etc.) and then performing the additional step of manually placing a phone call or typing in an URL to navigate to the designated website to conduct the transaction. As one can appreciate, this can be tedious, particularly if the communication information is shown only for a brief period of time.

Various embodiments are described for providing viewers with a fast and efficient means for conducting transactions using a communications device based on communication information being shown on a display terminal. Note, however, that the communication information does not always have to be displayed such that the communication is visible to the user. In accordance with some embodiments, a phone number or other type of communication information may be conveyed verbally by the host on a program and/or encoded in metadata associated with the program. This communication information (i.e., the phone number for this illustration) can then be obtained by the display terminal and sent to the communication device. In this regard, the communication information can be transmitted by various means of communication (e.g., visually, verbally).

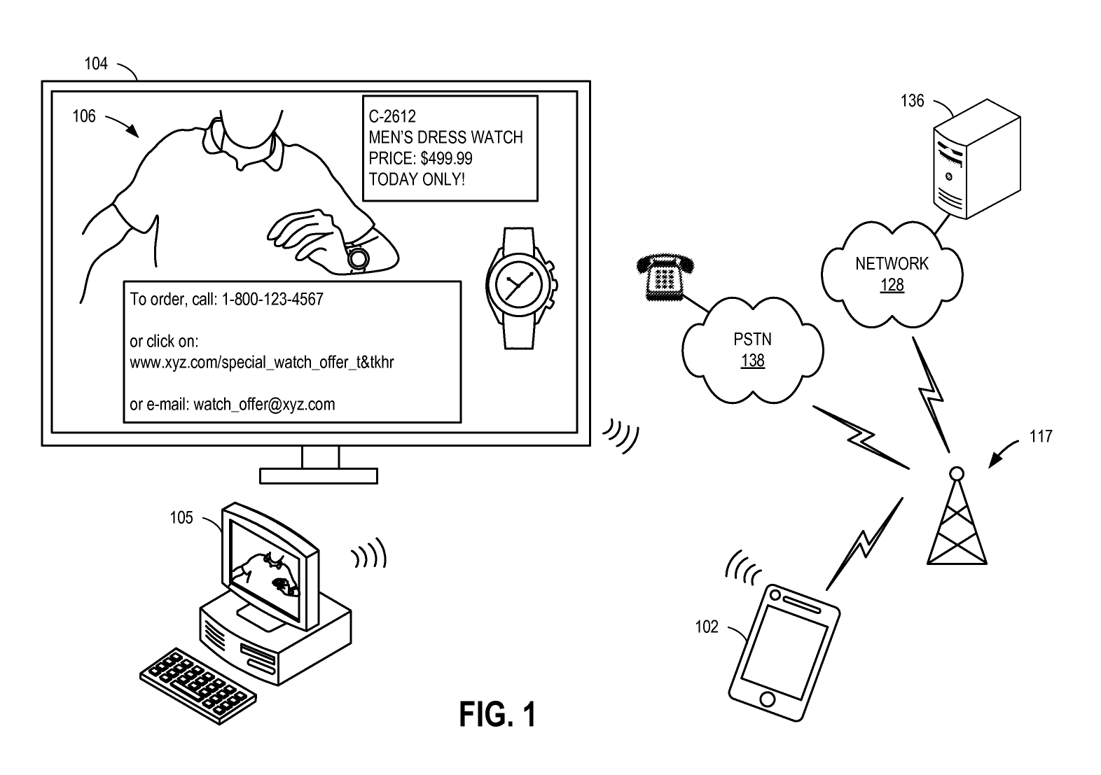

Reference is made to FIG. 1, which shows a networked environment in which a communications device and a display terminal operate in accordance with the quick link techniques described herein. The display terminal 104 may comprise but is not limited to, a television such as the one depicted in FIG. 1. In alternative embodiments, the display terminal 104 may comprise a display 105 coupled to a computing system. The communications device 102 may comprise a smartphone, tablet, and other computing devices with integrated communications capabilities.

In accordance with various embodiments, the communications device 102 is communicatively coupled to the display terminal 104, where the devices 102, 104 may be coupled by a wireless connection via a wireless local area network (WLAN), a Bluetooth connection, an infrared connection, and other wireless connection. In other implementations, the devices 102, 104 may be coupled by a wired connection such as, for example, an Ethernet cable. However, a wireless connection is generally preferable as a wireless connection allows the communications device 102 to remain portable.

Through the established communications link, the devices 102, 104 are able to exchange data. The communications device 102 is capable of supporting various types of communications, including, but not limited to, phone communications, short message service (SMS) messaging, e-mail communications, Internet-based communications, and so on. The display terminal 104 is configured to display media content 106 to a viewer and process the media content 106 in order to determine what communication types are associated with the media content 106. To illustrate, consider an example where the media content 106 comprises an advertisement such as the one depicted in FIG. 1, where the advertisement conveys communication information which a viewer can utilize to place an order or to obtain more information.

In the illustration of FIG. 1, a phone number, among other communication information, is displayed that the viewer can use to place a call to an operator to order the item (i.e., men's dress watch). In this example, the display terminal 104 determines that phone communications are associated with the media content 106 being shown. It should be emphasized, that in accordance with alternative embodiments, the determination of the means of communication may be performed on the communications device 102 side as well.

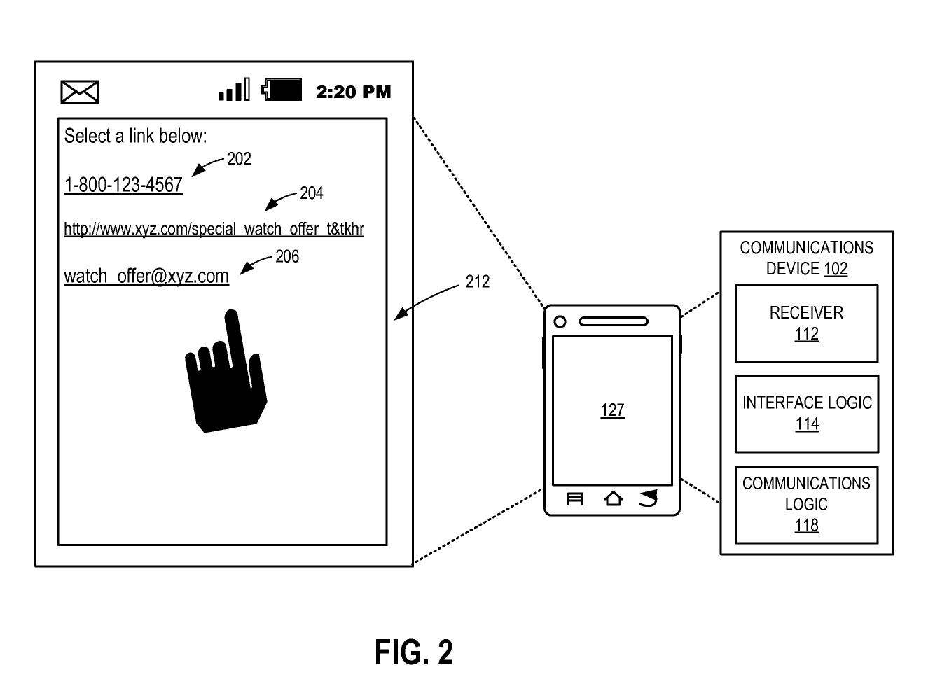

For embodiments where the display terminal 104 identifies or derives the communication information associated with the displayed media content 106, the display terminal 104 communicates the results to the communications device 102, which then generates a user interface for the user of the communications device 102. Reference is made to FIG. 2. As shown, the user interface displays the communication information derived by the display terminal 104 in FIG. 1, where the communication information may be displayed as quick links, for example, that allow the user to initiate a communications session to conduct a transaction or to obtain more information.

For example, one quick link 202 may be embodied in the form of a phone number based on communication information extracted from the media content 106 shown in FIG. 1. By selecting the link 202, the user initiates a phone call through the communications device 102. Note that the phone call may be established by the communications device 102 with another phone via the public switched telephone network (PSTN) or via a voice over Internet protocol (VoIP) connection. As another example, a second quick link 204 may be displayed as an URL. By selecting this second link 204, the user invokes a web browser on the communications device which navigates to the web site associated with the selected URL. As yet another example, a third link 206 may comprise an e-mail address. Upon selecting the link 206, a new e-mail message is displayed where the addressee field is automatically populated with the e-mail address. The user can then compose an e-mail message for obtaining more information or to place an order.

Other examples of quick links (not shown) may include instant message (IM) identifiers used for initiating an IM session, social networking profiles used for initiating a communications session with individuals associated with the profiles, and physical addresses for initiating mail communications. The IM identifiers may correspond, for example, to such services as Skype®, MSM®, a Hotmail® address, an Internet relay chat (IRC) channel identifier, and so on. The social networking profiles may be associated with any of a wide variety of social networking sites such as, for example, Facebook®, Twitter®, Plurk®, and so on. The physical address may be embodied in not only a standard mailing address, but also be in the form of a URL relating to a map generated by a web mapping service application such as, for example, Google Maps® and Mapquest®. For some embodiments, the user can simply tap on a quick link reflecting a physical address. Based on this, the communications device 102 may initiate network communications and launch a map application that downloads a map of a particular location, which is displayed to the user.

A description of the communications device 102 configured to provide quick links to a user for initiating communications is now described followed by a discussion of the operation of the components. Shown in FIG. 2 is a block diagram of a communications device 102 configured to communicate with the display terminal 104 of FIG. 1 and to provide quick links via a user interface. Generally, the communications device 102 will be embodied as a smartphone, a tablet, or other mobile device capable of executing various forms of communications. The communications device 102 includes a display 127, which may comprise a touchscreen for receiving traces, taps, or gestures from a user as inputs. The communications device 102 further comprises a receiver 112 configured to receive communication information. In operation, the receiver 112 receives communication information from the display terminal 104 in FIG. 1, where the display terminal 104 derived the communication information by analyzing the media content 106 being shown on the display terminal 104.

The communications device 102 further comprises interface logic 114 for displaying information for initiating communications according to the communication information using the device. Specifically, the interface logic 114 generates a user interface 212 that displays one or more methods of communication in the form of quick links. As described earlier in connection with FIG. 2, such quick links as a phone number 202, URL 204, and an e-mail address 206 may be shown, which the user can select from. The communications device 102 further comprises communications logic 118 configured to initiate communications based on input from a user regarding the displayed information. The user may initiate communications, for example, by simply tapping on one or more of the quick links 202, 204, 206 shown in the user interface 212.

If the user selects the first quick link 202, for example, the communications device 102 originates a phone call based on the telephone number shown without the user having to manually enter the phone number and thereby allowing the user to obtain more information or to conduct a transaction in an automated fashion. Referring back briefly to FIG. 1, the phone call may be placed by the communications device 102 via a cell tower 117 connected to the public switched telephone network (PSTN) 138. For communication types comprising e-mail or web-based communications, the communications device 102 may communicate over a network 128 to a remote server 136 or other entity.

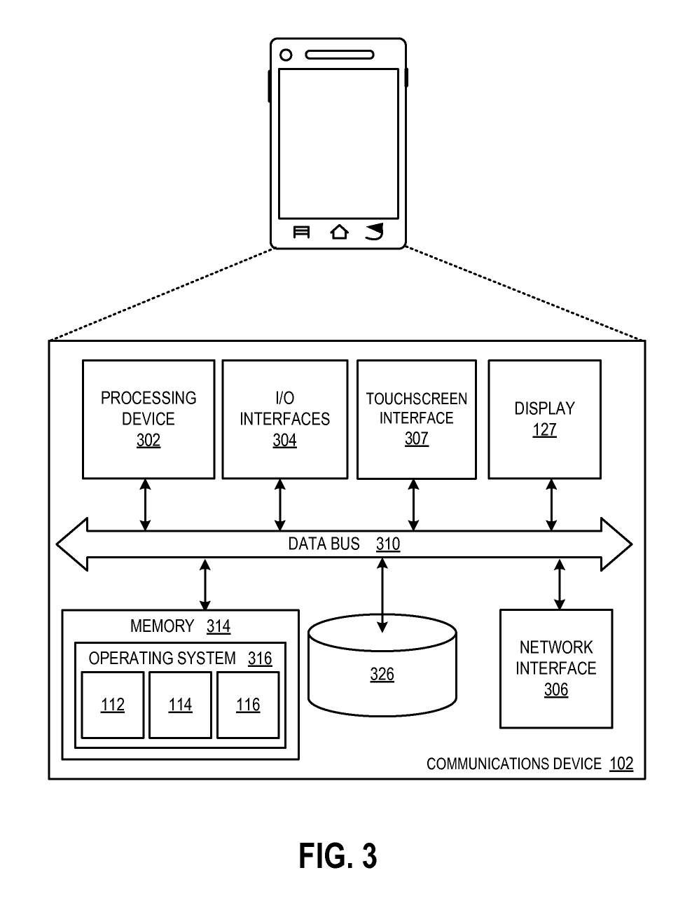

FIG. 3 illustrates an embodiment of the communications device 102 in FIG. 2. The communications device 102 may be embodied as a smartphone but may also be embodied in any one of a wide variety of computing devices. As shown in FIG. 3, the communications device 102 comprises memory 314, a processing device 302, a number of input/output interfaces 304, a network interface 306, a display 127, a touchscreen interface 307, and mass storage 326, wherein each of these devices are connected across a local data bus 310. The mass storage 326 may be used to store quick links generated by the communications device 102 for future access. Those skilled in the art will appreciate that the communications device 102 includes other devices not shown for purposes of brevity.

The processing device 302 may include any custom made or commercially available processor, a central processing unit (CPU) or an auxiliary processor among several processors associated with the communications device 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 314 can include any one of a combination of volatile memory elements (e.g., random-access memory (RAM, such as DRAM, and SRAM, etc.)) and nonvolatile memory elements. The memory 314 typically comprises a native operating system 316, one or more native applications, emulation systems, or emulated applications for any of a variety of operating systems and/or emulated hardware platforms, emulated operating systems, etc. For example, the applications may include application specific software which may comprise some or all the components 112, 114, 118 of the communications device 102 depicted in FIG. 2. In accordance with such embodiments, the components 112, 114, 118 are stored in memory 314 and executed by the processing device 302.

The touchscreen interface 307 is configured to receive input from a user via a display 127 and provides such functionality as on-screen buttons, menus, keyboards, etc. that allows users to navigate user interfaces by touch. One of ordinary skill in the art will appreciate that the memory 314 can, and typically will, comprise other components which have been omitted for purposes of brevity. With further reference to FIG. 3, network interface device 306 comprises various components used to transmit and/or receive data over a networked environment.

Note that in the context of this disclosure, a non-transitory computer-readable medium stores programs for use by or in connection with an instruction execution system, apparatus, or device. In this regard, one embodiment, among others, is a non-transitory computer-readable medium embodying a program executable in a computing device such as the communications device 102 in FIG. 1. In accordance with such embodiments, the program comprises code for retrieving communication information from a display terminal, code for displaying at least one quick link for initiating communications according to the communication information using the device, and code for initiating communications based on input from a user responsive to the at least one quick link being displayed.

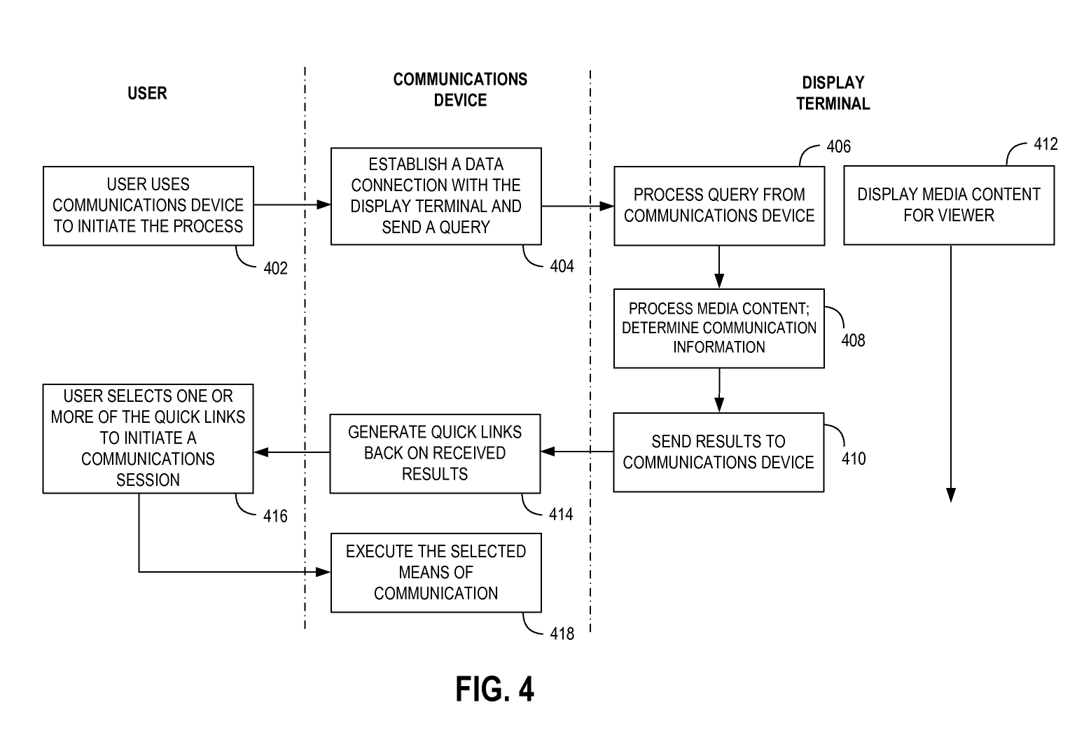

Reference is now made to FIG. 4, which is a flowchart in accordance with one embodiment for providing quick links implemented in the communications device 102 and the display terminal 104 of FIG. 1. If embodied in software, various blocks depicted in FIG. 4 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart in FIG. 4 shows a specific order of execution, it is understood that the order of execution may differ from that which is depicted. In block 402, the user of the communications device 102 (FIG. 2) triggers the quick link process where triggering the quick link process may comprise, for example, invoking an application. In block 404, the communications device 102 establishes a data communication with the display terminal 104 and sends a query to the display terminal 104 requesting information regarding the media content being displayed on the display terminal 104. As described earlier, the information may comprise communication types/methods being conveyed by the media content such as, but not limited to, phone number(s), URL(s), and/or one or more e-mail addresses.

In block 406, the display terminal 104 processes the query received from the communications device 102 and in block 408, the display terminal 104 processes the media content being displayed to determine communication information associated with the media content 106. At the same time, the display terminal 104 also displays the media content, where the media content 106 may comprise, for example, an advertisement whereby phone number(s), URL(s), etc. are being shown to the viewer for obtaining more information or for purchasing the item being shown (block 412). To illustrate, reference is made briefly to the example of FIG. 1, the communication information comprises a phone number, URL, and e-mail address for the men's dress watch shown in the media content 106 on the display terminal 104.

Referring back to FIG. 4, in block 410, the display terminal 104 sends the derived results to the communication device 102. In block 414, the communications device 102 generates quick links back on the received results, where each of the quick links invokes a communications session. For example, a quick link comprising a phone number invokes a phone call on the communications device 102. As another example, a quick link comprising an URL invokes a web browser on the communication device 102 where the web browser automatically navigates to the website associated with the URL. In block 416, the user selects one or more of the quick links to initiate a communications session. In block 418, the communications device 102 executes the selected means of communication.

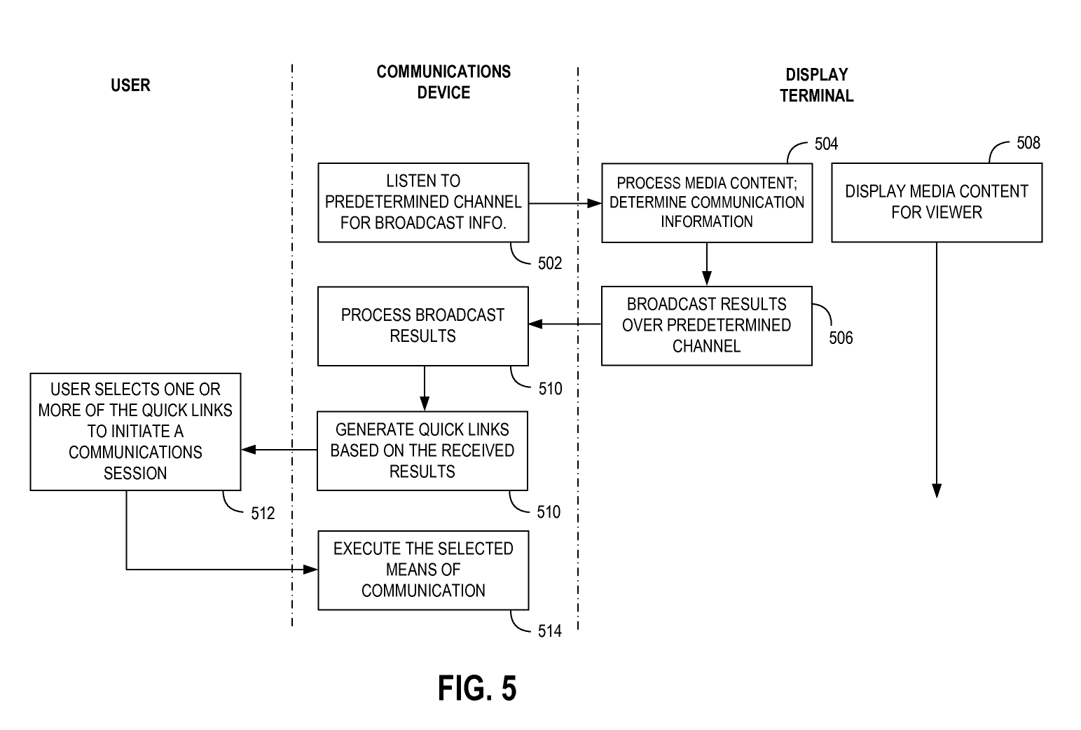

FIG. 5 is a flowchart in accordance with another embodiment for providing quick links implemented in the communications device 102 and the display terminal 104 of FIG. 1. Again, if embodied in software, various blocks depicted in FIG. 5 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart in FIG. 5 shows a specific order of execution, it is understood that the order of execution may differ from that which is depicted. In accordance with such embodiments, the display terminal 104 may be configured to broadcast communication information over a predetermined channel. In block 502, the communications device 102 (FIG. 2) monitors the predetermined channel for broadcast information sent by the display terminal 104. In block 504, the display terminal 104 processes the media content and determines communication information associated with the media content.

At the same time, the display terminal 104 also displays the media content, where the media content may comprise, for example, an advertisement whereby phone number(s), URL(s), etc. are being shown to the viewer for obtaining more information or for purchasing the item being shown (block 508). In block 506, the display terminal 104 broadcasts the derived results on the predetermined channel. In block 510, the communications device processes the broadcast results and generates quick links based on the received results. In block 512, the user selects one or more of the quick links to initiate a communications session. In block 514, the communications device 102 executes the selected means of communication.

Note that in accordance with some embodiments, the communication device may be configured to function as a remote control for the display terminal. For such embodiments, the communication device functioning as a remote control includes a user interface (UI) shown on the display of the communications device. The user can select an icon on the UI to perform a query via communication information just received (through the process outlined in the flowchart for FIG. 4). For other embodiments, a clickable icon is shown on the UI of the remote control only if the communications device has received one or more valid communication information from the display terminal. (Refer to FIG. 5).

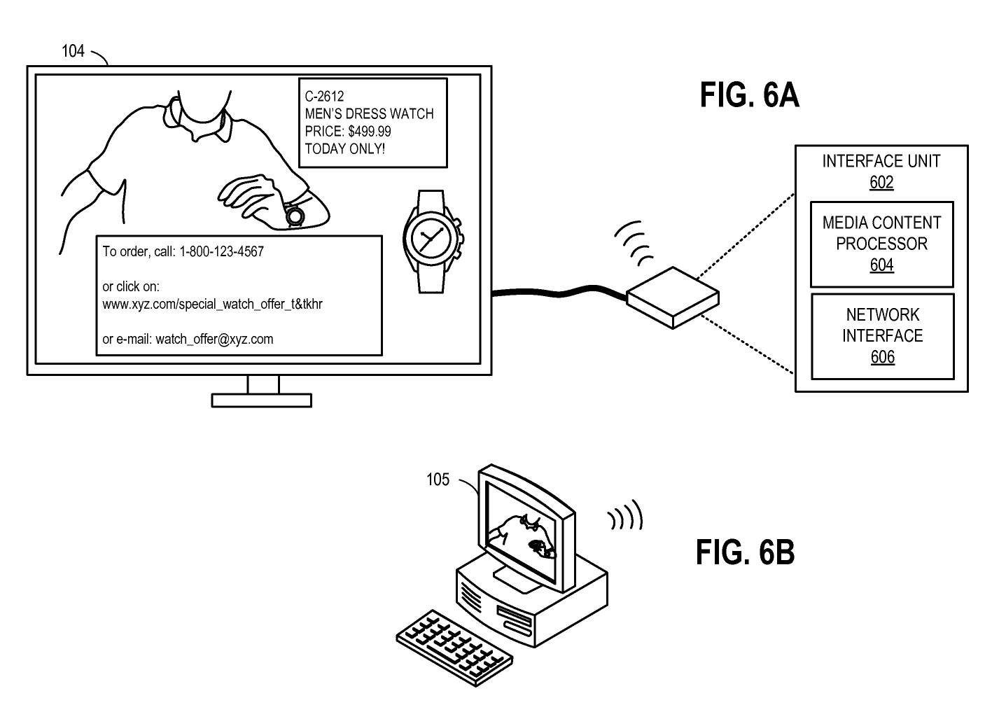

Reference is made to FIGS. 6A-B, which show embodiments of the display terminal 104 of FIG. 1 for implementing the quick link technique described. As shown in FIG. 6A, for some embodiments, the display terminal 104 may comprise a standard television coupled to an interface unit 602 configured to communicate with the communications device 102 of FIG. 1. For such embodiments, the display terminal 104 comprises a media content processor 604 configured to derive communication information associated with the media content.

This may comprise, for example, capturing one or more images of the media content and determining whether text is present in the media content by performing, for example, optical character recognition techniques. If any text is identified, the media content processor 604 determines whether the text matches any predetermined patterns. For example, the media content processor 604 may determine whether identified text matches a phone number format or an URL format. In some cases, the media content 106 being shown on the display terminal 104 may include embedded metadata relating to the contents of the media content. The metadata may be embedded, for example, in the Extensible Metadata Platform (XMP) format.

Aside from such information as the media content title, creator, description, etc., the metadata may also include such information as communications methods associated with the media content 106 that a viewer may utilize to conduct a transaction. In such cases, the media content processor 604 extracts the embedded metadata from the media content 106 and retrieves the communications methods described by the metadata. The interface unit 602 further comprises a network interface 606 for communicating with the communications device 102. One skilled in the art will appreciate that any wireless/wired interfaces may be implemented.

Note that while a separate interface unit 602 is depicted in FIG. 6A, the interface unit 602 may also be integrated into a television or other display device whereby separate hardware is not required. For example, as depicted earlier in FIG. 1 and as shown in FIG. 6B, the display terminal 105 may comprise a display coupled to a computing system. For such embodiments, the various components depicted in FIG. 6 may be embodied as software stored on a non-transitory medium and executed by a processing device within the computing system.

Note also that in accordance with alternative embodiments, the functionality described above for the display terminal 104 may be performed within the communications device 102 such that comparable functionality is implemented locally within the communications device 102. For example, upon viewing an advertisement on the display terminal 104, the user may invoke an application on the communications device 102 to capture a snapshot of the media content while communication information is being shown. The communications device 102 processes the media content and extracts communication information. Based on the communication information, quick links are generated by the communications device 102 and presented to the user. The user then initiates one or more communications session by selecting one or more of the quick links.

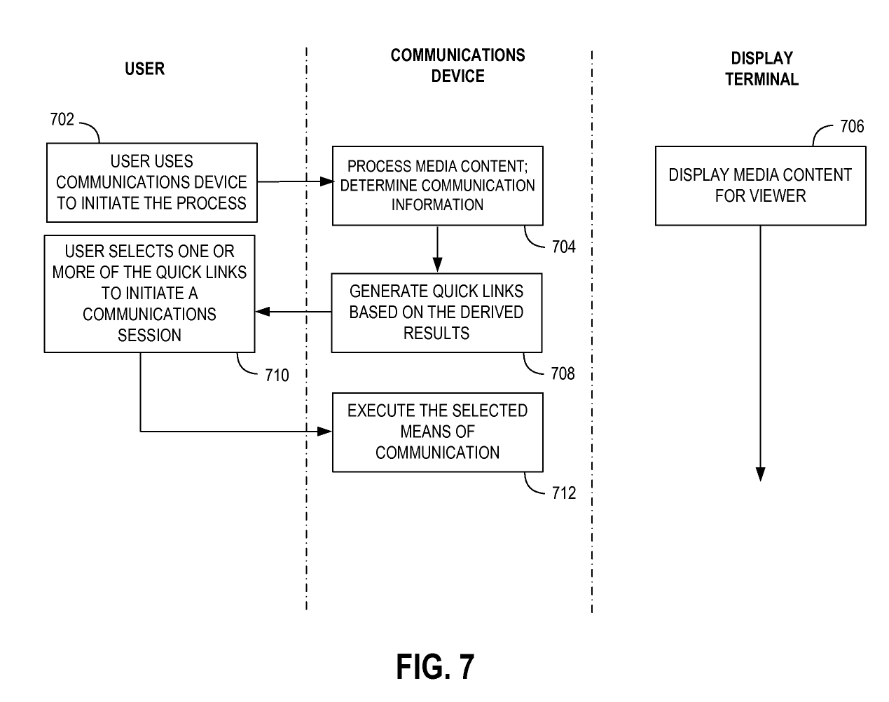

FIG. 7 is a flowchart in accordance with another embodiment for providing quick links, whereby processing of media content is performed locally at the communications device 102 show in FIG. 2. Again, if embodied in software, various blocks depicted in FIG. 7 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart in FIG. 7 shows a specific order of execution, it is understood that the order of execution may differ from that which is depicted. In accordance with such embodiments, the user uses the communications device 102 depicted in FIG. 2 to initiate the process (block 702). The user may do this by invoking an application on the communications device 102 (FIG. 2). In block 704, the communications device 102 processes the media content 106 and analyzes the media content 106 to determine communication information associated with the media content 106, where the media content 106 is being shown on the display terminal (block 706). In block 708, the communications device generates quick links based on the derived results. In block 710, the user then selects one or more of the quick links to initiate a communications session. In block 712, the communications device 102 executes the selected means of communication.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A method for initiating communications on a communications device, comprising:
retrieving, by the communications device, communication information from a display terminal, the communication information being derived by the display terminal;
displaying, by the communications device, at least one quick link according to the communication information;
based on a user input relating to the at least one quick link, initiating, by the communications device, a communications session.

2. The method of claim 1, wherein the communication information is derived by the display terminal by performing optical character recognition responsive to communication information being shown on the display terminal.

3. The method of claim 1, wherein the communication information is derived by the display terminal from metadata associated with a program being shown on the display terminal.

4. The method of claim 1, wherein the communication information is derived by the display terminal from a server associated with a program being shown on the display terminal.

5. The method of claim 1, wherein retrieving the communication information is by receiving communication information being broadcasted by the display terminal.

6. The method of claim 1, wherein retrieving the communication information is by sending a request for the communication information to the display terminal by the communications device.

7. The method of claim 1, wherein the communication information comprises one or more of:
one or more telephone numbers;
one or more Uniform Resource Locators (URLs);
one or more instant message (IM) identifiers;
one or more e-mail addresses;
one or more social networking profiles; and
one or more physical addresses.

8. The method of claim 7, wherein initiating communications comprises:
based on the user input relating to the at least one quick link, the communications device performing one or more of:
initiating one or more phone calls or sending one or more messages if the communication information comprises one or more telephone numbers;
displaying a website if the communication information comprises one or more URLs, wherein the website is associated with the one or more URLs;
initiating an instant messaging session if the communication information comprises one or more IM identifiers;
initiating e-mail communications if the communication information comprises one or more e-mail addresses;
initiating communications with one or more individuals associated with the one or more social networking profiles if the communication information comprises one or more social networking profiles; and
initiating a map application if the communication information comprises one or more physical addresses.

9. The method of claim 1, further comprising:
based on a second user input regarding the at least one quick link, storing at least a portion of the communication information in the communications device for future access.

10. A system, comprising:
a communications device, the communications device comprising:
a receiver configured to retrieve communication information from a display terminal, the communication information being derived by the display terminal from media content associated with the communication information;
interface logic for providing a user interface comprising at least one quick link for initiating communications according to the communication information;
communications logic configured to initiate communications based on at least one selection by a user of the at least one quick link.

11. The system of claim 10, wherein the display terminal derives the communication information by performing optical character recognition upon communication information being shown on the display terminal.

12. The system of claim 10, wherein the communication information is derived by the display terminal from metadata associated with a program being shown on the display terminal.

13. The system of claim 10, wherein the communication information is derived by the display terminal from a server associated with a program being shown on the display terminal.

14. The system of claim 10, wherein retrieving the communication information is by receiving communication information being broadcasted by the display terminal.

15. The system of claim 10, wherein retrieving the communication information is by sending a request for the communication information to the display terminal by the communications device.

16. A non-transitory computer-readable medium embodying a program executable in a computing device, the program comprising:
code for retrieving communication information from a display terminal;
code for displaying at least one quick link according to the communication information using the device; and
code for initiating communications based on input from a user responsive to the at least one quick link being displayed.

17. The non-transitory computer-readable medium of claim 16, wherein the communication information is derived by the display terminal by performing optical character recognition responsive to communication information being shown on the display terminal.

18. The non-transitory computer-readable medium of claim 16, wherein the communication information is derived by the display terminal from metadata associated with a program being shown on the display terminal.

19. The non-transitory computer-readable medium of claim 16, wherein the communication information is derived by the display terminal from a server associated with a program being shown on the display terminal.

20. The non-transitory computer-readable medium of claim 16, wherein code for retrieving communication information is configured to receive the communication information being broadcasted by the display terminal.

21. The non-transitory computer-readable medium of claim 16, wherein code for retrieving communication information is configured to transmit a request to the display terminal for the communication information.

22. The non-transitory computer-readable medium of claim 16, further comprising code for storing at least a portion of the communication information in the computing device, wherein the at least a portion of the communication information being stored is used for initiating at least one future communications session.
